(19) United States
(12) Patent Application Publication
(10) Pub. No.: US 2008/0235360 A1
(43) Pub. Date: Sep. 25, 2008

(54) System and Method for Scheduling Downloading in a Cached Network Environment

(75) Inventors: Jun Li, Plainsboro, NJ (US); Junbiao Zhang, Bridgewater, NJ (US); Snigdha Verma, Somerset, NJ (US)

Correspondence Address: Joseph J. Laks;Thomson Licensing LLC, 2 Independence Way, Patent Operations, PO Box 5312, PRINCETON, NJ, 08543, US

(73) Assignee: Joseph J. Laks, Patent Operations, PRINCETON, NJ (US)

(21) Appl. No.: 10/592,629

(22) PCT Filed: Mar. 12, 2004
(86) PCT No.: PCT/US2004/007651

§ 371 Date: Sep. 12, 2006

(51) Int. Cl. G06F 15/16

(52) U.S. Cl. 709/223

(57) ABSTRACT

A system and method schedules downloading of content files from a content server to a client through a cache server. A user can request a content file for future delivery at a certain service time at a certain location such as a hotspot. A cache server receives these requests and sorts them in an order which depends on the relative service times, and eliminates redundancies by only downloading content files not already stored in the cache server. A scheduling algorithm minimizes the instances of tardiness under the constraint of cache storage capacity.

### FIELD OF THE INVENTION

The present invention relates generally to the field of data communication and content delivery networks, and specifically to systems and methods for scheduling downloading of files in content delivery networks.

### BACKGROUND OF THE INVENTION

For large size content, such as movies, content clients usually can tolerate some delay in delivery in exchange for better quality. Often, a client will choose to rather watch a high quality downloaded video at a scheduled time rather than view a low quality streaming video instantaneously. For example, a mobile user can order a video in advance while he or she is on a cellular mobile network and download the movie at a later time while the user accesses a wireless LAN hotspot. In this way, the mobile user can enjoy content at a high bandwidth and a low cost.

In recent years, the use of content delivery network (CDN) technology has spread to the Internet to improve the downloading of web pages. A CDN comprises a plurality of cache servers at different geographic locations. The basic premise of CDN technology depends on low cost and high bandwidth links between the cache server and the client If at the time a client requests a web page, the requested web page exists in the cache of a nearby cache server, the downloading occurs quickly. Otherwise, the client may experience a delay.

Typically, a client can tolerate a delay in the downloading of a large size content file, provided the delay does not extend past an expected service time at which the content client designates as the time he or she wishes to retrieve the content file. Thus, even if the requested content file does not currently exist in a cache server close to the client, so long as the downloading system transfers the content file to the cache server prior to the expected service time, the client will not experience a delay. However, when a content server receives a number of client requests to download content files to a specific cache server, a scheduling algorithm must be used to optimize the resources of the content server, the network links, and the cache server.

The advancement of wireless technology and the introduction of remote site downloading has increased the need for scheduling algorithms that optimize the resources of the content server, the network links, and the cache server. For exemplary purposes only, these scheduling problems will be discussed in relation to CDNs using wireless and remote site downloading technology with the understanding that these problems exist in all types of CDNs and the present invention is not so limited.

With the advancement of wireless technology, mobile/wireless devices such as personal data assistants (PDAs), cellular telephone-PDA hybrids, and lap-top computers can use cellular mobile networks to send and receive e-mails, obtain web services, and download multimedia files. However, using such cellular networks is not efficient for downloading or streaming large content files such as movies, music, television programs, or other multimedia files. The cost per delivered multimedia bit and speed make it more cost-efficient for the mobile device user to use a higher bandwidth connection, such as cable broadband, DSL, telephone modem, or other hard-wired network connection to download such content files from a content web server.

When travelling, a mobile device user often only has access to a less cost-efficient network, such as a cellular network (i.e., a low bandwidth network). In order to alleviate the problems and constraints associated with downloading large content files over cellular networks, cached server networks, also known as content delivery networks (“CDNs”), are becoming more common. The CDNs contract with web site operators to make certain of the web sites' content files available from cache servers so that a user request to the web site content server can be fulfilled or delivered more quickly, efficiently, and/or geographically closer from a cache server in the CDN. For example, a downloading system allows a user to request a content file from a content server while at one location, on a first network at a first time, and download the content file at a second location and/or on a second network and/or at a future second time. This is known as a remote site downloading function. A remote site downloading function may be provided by CDNs or content servers.

In order to meet these needs, public access points known as a “hotspots” have been developed that facilitate cost-efficient downloading through the use of a cache server. As used herein, a hotspot is a location where a Wireless Local Area Network (“WLAN”), e.g., a wireless broadband computer network in a public space, has been established. Hotspots currently offer connection speeds of 1 megabits per second using IEEE 802.11b (“Wi-Fi”) standard or 55 megabits per second using IEEE 802.11g, and may be located in coffee shops, restaurants, hotels, airports, bookstores, copy shops, convention centers, and other publicly accessible locations, for example. At hotspots, a user with a Wi Fi-enabled mobile device such as a PDA, laptop computer, cellular telephone, or hybrid PDA-cell phone, for example, can access the Internet and download or stream large content files very cost-efficiently.

Internet access at hotspots is generally provided to users' mobile devices by a wireless router with a radio transceiver that communicates with the mobile device having a wireless card. A mobile user which is not Wi-Fi enabled may connect to the hotspot Internet server in some cases with a wire connection, although in the future all mobile devices are expected to be Wi-Fi enabled.

Presently, a wireless mobile device user can access the Internet at a hotspot to select, request, and pay for, a content file from a remote content web server for immediate downloading. However, the mobile user often will find it convenient to select a content file from a content provider web site via a cellular or other lower speed network and have the content file downloaded in advance for immediate access when the mobile user visits the hotspot without having to connect to the content server web site during the visit to obtain the content file. In this situation, the mobile user generates a request for a content file via their mobile/wireless device, specifying the hotspot/cache server to which the content is to be sent and an estimated time at which he or she wishes to access and receive the content (i.e., a service time).

While requesting that files for downloading to a hotspot cache server has certain advantages, users have encountered a number of problems with current networks, one of which is tardiness in the requested content file arriving at the specified cache server. Often the user must wait beyond the estimated service time for the requested content to become accessible on the cache server. This problem is becoming worse as the popularity of cached network downloading continues to grow.

The downloading processes in most Internet services generally occur almost instantly regardless of server, network, and client conditions. Few if any scheduling problem exist in instant downloading systems. The scheduler in such systems operates on the basis of the content server's processing capacity and the processing of requests for files occurs in the order such requests are received. However, as advance requests with service time information grow more numerous, a need will exist for designing a scheduler for downloading content files in a cached network (CDN) environment that takes into consideration the special constraints present in such networks.

### DISCLOSURE OF THE INVENTION

It is an object of the present invention to provide a method and system for scheduling downloading jobs for a downloading system.

Another object is to provide a method and network for scheduling download in a downloading system that reduces instances of downloading tardiness with respect to service time.

Yet another object is to provide a method and network for scheduling download in a downloading system that maximizes cache server utilization.

A still further object is to provide a method and network for downloading in a downloading system that eliminates storing duplicative content files on a cache server.

It is another object of the present invention to provide a method and network for scheduling downloading in a downloading system that considers both content server and cache server capacities.

These objects and others are met by the present invention. In a downloading system, it has been discovered that since requests for downloading content files are made in advance of content service time (i.e., content consuming time), a method and network can be devised for scheduling downloading that will improve the throughput of the system. The objective is to maximize the network throughput under the constraints of server, network and cache capacities. The invention can be used in both wired and wireless network environments.

In one aspect, the invention is a method of scheduling downloading for a downloading system environment comprising: receiving a request for a content file having a service time at a specified cache server; and listing the request in a job list in chronological order according to service time. A request can also have a data set of content file URL, and a content file size. There is a scheduling pointer that is initialized to the top of list. The job list is preferably dynamically updated as new requests for content files are received and the scheduling pointer is moved backward if a new request is inserted before the request currently indicated by the scheduling pointer. Once the job list is created and arranged, it is determined whether the content file required by the request at the scheduling pointer is already stored on the specified cache server. If it is determined that the content file required by the request at the scheduling pointer is not stored on the specified cache server, that content file will be requested to be downloaded to that cache server when free space becomes available. Upon this downloading being completed, the downloaded content will have a link to the request at the scheduling pointer and the scheduling pointer will be moved forward to the next request on the job list.

However, if the content file required by the request identified by the scheduling pointer exists on the cache server, the request is preferably linked to the stored content and then the scheduling pointer is moved forward to the next request on the job list. This eliminates content files being duplicatively stored on the same cache server, maximizing cache server storage utilization.

The present invention takes into consideration not only content server processing capacity but also considers cache server capacities, such as storage space. A cache server cannot process the next job (i.e., download the requested content file) on the list unless the cache server has free space to hold the file. Because cache server free space depends on client's random pick-ups rather than the expected service time of a request, it is preferred that the cache server free space be continuously monitored. The present invention maximizes throughput under the constraints of server and cache capacities.

Preferably, content files will be downloaded to the specified cache server from a content source. As used herein, a content source includes a content web server or an unspecified cache server that contains the desired content file. The job list can be stored on and executed by the specified cache server. It is further preferable that the specified cache server be a hotspot cache server. Requests can be generated by wireless or wired user devices, including mobile electronic devices such as PDA's, cell phones, lap tops, or fixed devices such as desktop computers.

In another aspect, the invention is a system comprising: a cache server having a job list and content storage space; a user device adapted to generate a request for a content file to be available on the cache server, the request having a service time; means to add the request to the job list, the job list arranged in chronological order according to service time and having a scheduling pointer initialized at the top of the job list; means to determine whether the content file required by the request at the scheduling pointer is stored on the cache server; means to download the content file required by the request at the scheduling pointer-to the cache server when free space is detected on the cache server and when it is determined that the content file required by the request at the scheduling pointer is not stored on the cache server.

Preferably, the system should have means to move the scheduling pointer forward to the next request on the job list when the content required by the request identified by the scheduling pointer is downloaded. Further, the system preferably comprise means to move the scheduling pointer forward to the next request on the job list when the content file required by the request at the scheduling pointer exists on the cache server. In both embodiments, the system can comprise means to create a link from the content file required by the request at the scheduling pointer to the request before forwarding the scheduling pointer to the next request on the job list.

The inventive system can further comprise a content source for downloading content to the cache server. The content source can be a content server, or another cache server.

### BRIEF DESCRIPTION OF THE DRAWINGS

FIG. 1 illustrates a schematic of a downloading system, where the content requesting and content downloading use different networks, according to one embodiment of the present invention.

FIG. 2 depicts a flowchart of a method for scheduling downloading in a remote downloading system according to one embodiment of the present invention.

### MODES FOR CARRYING OUT THE INVENTION

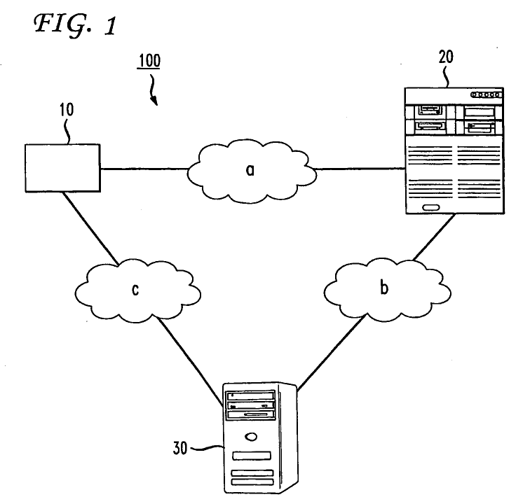

FIG. 1 illustrates a downloading system 100. The downloading system 100 comprises user device 10 (generically illustrated as a rectangular box), content server 20, and cache server 30. User device 10 communicates with and transmits data to and receives data from content server 20 via a first network a which in this example comprises a wireless cellular network operating at a relatively low speed (i.e., low bandwidth). Content server 20 communicates with and transmits data to and receives data from cache server 30 over a second network b such as the Internet having high speed (i.e., high bandwidth). Cache server 30 and user device 10 communicate with each other and transmit and receive data locally at hot spot c, which can offer a wireless or hard-wire connection, for example at a coffee shop or airport.

User device 10 in this example comprises a wireless device, such as a web-enabled PDA or cellular phone. Content server 20 in this example comprises a web site where movies can be purchased and downloaded. Cache server 30 in this example comprises a hotspot cache server accessible by multiple users.

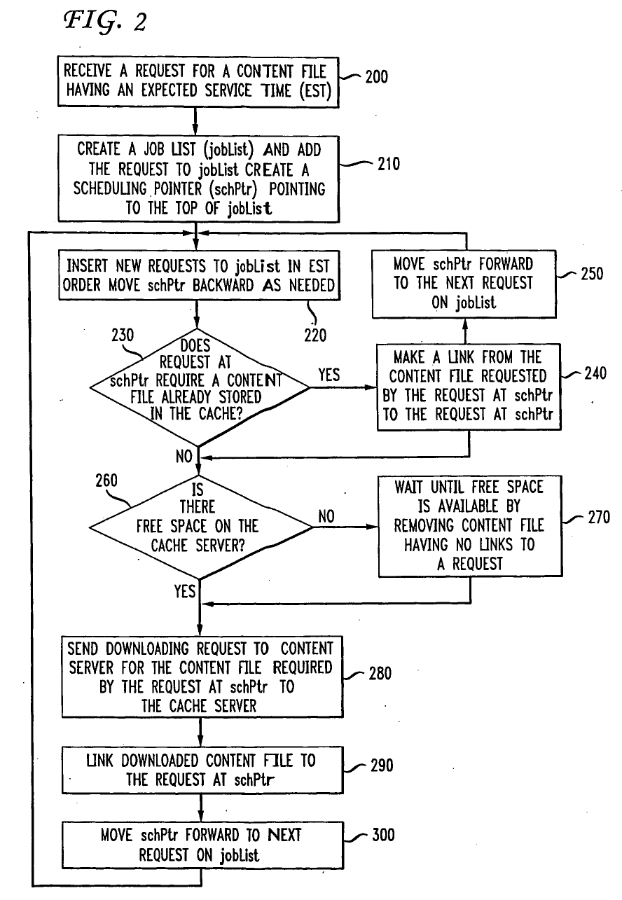

FIG. 2 illustrates a flowchart of how downloading system 100 operates according to one embodiment of the present invention. While FIG. 2 will be discussed in relation to the downloading system 100 of FIG. 1, it is understood that various embodiments and hardware can be substituted.

When a user decides to obtain a content file at a later time but wishes to request the content file immediately, the user generates a request for the desired content file via user device 10 at a first remote location. The request will include a service time at which the user desires to obtain the file. The request also will specify a cache server, at which the user wishes to retrieve the content file directly or indirectly. Alternatively, the request can be assigned to a specific cache server for retrieval by the downloading system 100. Upon generating the request with user device 10, the request passes directly to cache server 30 or indirectly via content server 20.

Cache server 30 receives the request for the content file during step 200 of FIG. 2. Upon receiving the request, cache server 30 determines the service time associated with the request and adds the request to a job list containing previous requests during step 210. The job list comprises a list of all of the requests for content files received by cache server 30 for processing. Cache server 30 arranges the job list so that the requests appear in chronological order according to service time during step 220. Cache server 30 has a scheduling pointer initialized to the top of the job list. Because new requests often arrive constantly at the cache server 30, the cache server dynamically updates the job list and will move the scheduling pointer moved backward upon insertion of the new request before the request heretofore identified by the scheduling pointer. A properly programmed processor and conventional hardware (not shown) will carry out all process steps and decisions.

At any time that the job list is updated and arranged, the scheduling pointer points to a request on the job list, which is the request to be scheduled. During step 230, the cache server 30 determines whether the request currently identified by the scheduling pointer on the job list requests a content file that already stored within the memory of cache server 30. If so, the cache server 30 proceeds to step 240. During step 240, the cache server links this content file to the request identified by the scheduling pointer so that the corresponding user can retrieve the desired content file upon accessing the cache server with user device 10 following arrival at the hotspot location. Upon completion of step 240, the scheduling pointer advances forward to the next request on the job list during step 250. This eliminates storing duplicative content files within the memory of cache server 30, thus saving and maximizing the cache server's limited memory space.

However, if the requested content does not exist upon a check of the cache server 30 during step 230, step 260 occurs, and a determination is made whether sufficient free space exists on cache server 30 to download the content file specified in the request identified by scheduling pointer. As used herein, free space exists when there is adequate memory space on cache server 30 to store the content file associated with the request at the scheduling pointer without overwriting linked content files. This circumstance exists when there is either sufficient empty space on the cache server memory or when a content file that is stored in the memory can be replaced. A content file stored in the memory can be replaced when there is no link to any request for that file. A link to a request will be deleted when either the corresponding user for the request picks up (i.e., downloads) that content file to user device 10 or when the request expires (i.e., a certain amount of time has passed beyond the estimated service time).

If sufficient space does not exists during execution of step 260, step 270 occurs at which time, the cache server 30 processes existing linked jobs until free space becomes available before proceeding to re-execute step 260.

When sufficient space exists during step 260, then step 280 occurs and the cache server 30 sends a signal to content server 20 requesting the content file required by the request identified on the job list by the scheduling pointer. Content server 20 responds to signal with the time granted the cache server to download the content file required by the request identified by the scheduling pointer and the content file is downloaded to the cache server 30 at the granted time for storage during step 280. Upon completion of the downloading, the request at the scheduling pointer is linked to the downloaded file during step 290. Thereafter, the scheduling pointer moves forward to the next request on the job list during step 300 before proceeding back to step 220.

The present invention has as one of its objects, the minimization of the number of jobs that extend after the expected service time considered as a tardiness penalty to the downloading system. While ordinary computer clients can request downloading as early as the server has capacity without a so-called earliness penalty, in CDNs, the cache server cannot request a downloading as early as the server has capacity. This implies an earliness penalty. The use of cache server storage is the penalty of earliness. The longer a given content remains in the cache the larger the cost or penalty will be. Assuming the total cache server storage has a fixed storage capacity will simplify the problem. Therefore the earliness penalty becomes an earliness constraint. One objective of the present invention is to minimize the number of tardiness penalties with a fixed earliness constraint.

Note that request processing (such as for downloading) the arrival of a new request does not have to trigger request processing. Request arrival and request processing can exist orthogonal to each other wherein insertion of a new arrival is inserted into the request list constitutes the only connection occurring between the request arrival and request processing.

For descriptive purposes, the scheduling algorithm illustrated in FIG. 2. is called Earliest Transmission in Service Order (“ETSO”) based on above objective and constraint. The ETSO scheduling algorithm tries to transmit a content file as early as possible subject to the cache server constraint to maximize the utilization of both transmission capacity and cache server capacity. The ETSO algorithm can operate both in real-time as well as offline. The real-time case occurs when new requests arrive as the request processing progresses. The offline case assumes that all requests with their expected service times are available before starting the request processing. In the offline case, the ETSO algorithm proves itself as an optimal algorithm in the case where the content size is a constant. In the case of variable content sizes, the optimization objective is related not only to the number of tardy jobs or tardiness rate, i.e., missing their deadlines, but also to the total size of the content for tardy jobs. Such an objective function can sometimes require transmission not in the expected service time order since the server could need to process a larger or smaller content with a later expected service time in order to meet the objective. This will happen when a job processes close to its expected service time. If the system design can give a low tardiness rate, this won't happen very often. Therefore, although the earliest transmission in service order (ETSO) algorithm is no longer optimal, the principle of earliest transmission with cache constraint is still valid and can be used in a variable content size system.

The scheduling problem in this invention can be defined as follows: On the content server, there are K different content files. All content files have equal size, requiring the same amount of time p to be downloaded to the cache server. On the cache server, there is a set of requests R={rᵢ} with size of N for a period of time T. The cache size is C. Each request rᵢ=(kᵢ, dᵢ) is for a content kᵢ and has an expected service time dᵢ. Without loss of generality, the order of the expected service times for N requests is dᵢ<dⱼ, if i<j. The scheduling problem is to find a sequence of time S={sᵢ}, where sᵢ is the time that the request i is scheduled. We can define “scheduled” as the time that the requested content is downloaded to the cache server, i.e., the end of transmission instead of start of transmission. We are looking for a schedule S, which yields a minimum number of service tardiness, i.e., the number of occurrences of sᵢ>dᵢ.

A suitable ETSO schedule S_{ETSO} follows the following steps:
1. The request r₁ is scheduled at s₁=d₁, let d₁′=d₁, dᵢ′ is the time until then that kᵢ must be in cache. Let current schedule time t=s₁.
2. For i=2, to N, (number of requests)
A. if content file kᵢ is in cache, let sᵢ=t, dⱼ′=t−p, where j is the last request for the content file kᵢ, else
B. wait until t′≧t, so that G_{S}(t′)<C/p, if dᵢ≧t′+p, let sᵢ=t′+p, dᵢ′=dᵢ, and t=t′+p, else
C. sᵢ=∞ (failure to schedule, tardiness++).
G_{S}(t)=Σᵢp [Θ(t−sᵢ+p)−Θ(t−dᵢ′)] is the total size of content that must be hold in the cache at the current time t, where Θ(x) is a unit step function, i.e., Θ(x)=1, if x>0, otherwise Θ(x)=0; Θ(t−sᵢ+p)−Θ(t−dᵢ′) means the cache requirement of the request i, from its starts of transmission (sᵢ−p) to its service time (dᵢ) or the starts transmission of the next same content request (dᵢ′).
The first step is the initialization and the second step is a loop to schedule all requests until r_{N}. The steps in the loop can be explained as follows:
Step 2A: the requested content is in the cache. Schedule request rᵢ at current time. Since the request rᵢ requires the content kᵢ be stored in the cache until dᵢ≧dⱼ for j<i, there is no need for request rⱼ to ask for content kᵢ (=kⱼ) to be stored more than sᵢ−p. Introducing d′ is to avoid over count the cache storage, i.e., using d′ in the G_{S}(t) will not have the periods of caching overlapped for the same content.
Step 2B: if cache is full, we need to wait until t′, when at least one content having all its scheduled requests got serviced. If we still have time to download, i.e., dᵢ≧t′+p, we schedule the request rᵢ at sᵢ=t′+p. It is a newly cached content, so kᵢ must be stored until dᵢ′=dᵢ. Time progress t=t′+p.
Step 2C: if no time to download, let sᵢ=∞. A failure to schedule happens.

The ETSO scheduling algorithm tries to transmit a request as early as possible subject to cache constraint. It maximizes the utilization of both transmission capacity and cache capacity. It can be proven that the ETSO algorithm is an optimal algorithm for the given objective function, i.e., minimizing the number of tardiness occurrences. For up to i requests, an optimal schedule is a schedule (1) with minimum number of tardiness and (2) with the earliest schedule time for the last schedule sᵢ.

We assume the first request has a fixed schedule s₁=d₁, meaning time starts at t=d₁−p. The second request can be proved as optimal according to ETSO. That is, the earliest time is at t+p. If t+p>d₂, s₂=t+p makes a tardiness, so we need to schedule the 3rd request and so on. Without loss of generality, we assume d₂≧d₁+p. It is obvious that S₂={s₁=d₁, s₂=d₁+p} is an optimal schedule by above two criteria.

Using inductive method, we assume that until the request rᵢ, the ETSO algorithm is optimal with a schedule Sᵢ={s₁ . . . sᵢ}. If the content kᵢ₊₁ for request rᵢ₊₁ is in cache at current time t=sᵢ, t′=t=sᵢ. In this case, Sᵢ₊₁* has equal tardiness and equal last schedule time. So Sᵢ₊₁={Sᵢ, sᵢ₊₁=sᵢ} is optimal. If content kᵢ₊₁ for request rᵢ₊₁ is not in cache, and rᵢ₊₁ is scheduled after previous requests, according to ETSO algorithm, Sᵢ₊₁*={Sᵢ, sᵢ₊₁=t′+p} is the earliest schedule for rᵢ₊₁, where t′≧sᵢ, is the smallest value satisfying G_{Si}(t′)<C/p. Since the cache status G_{Si}(t) won't be affected until t′. The ETSO algorithm chooses the earliest possible sᵢ₊₁ after sᵢ. In this case the schedule Sᵢ₊₁*={s₁, . . . ,sᵢ₊₁}, must be optimal as well.

However, can we schedule request rᵢ₊₁ between previous i schedules? Assuming a schedule Sᵢ₊₁={sₐ, . . . , sᵢ₊₁=t₁, s_{b}=t₂, . . . , s₁=tₘ} exists, it can be proven that the number of tardiness for all possible Sᵢ₊₁ is greater or equal to Sᵢ₊₁*.
Since we have dᵢ₊₁≧d₁≧s₁, a valid schedule Sᵢ₊₁ must satisfy cache constraint G_{S}(t). Considering a schedule S′ᵢ₊₁={sₐ, . . . ,s_{b}=t₁,sᵢ₊₁=t₂ . . . ,s₁=tₘ}, which swaps the schedule S for requests r_{b} and rᵢ₊₁. Then for request r_{b}, the difference of cache occupancy is [Θ(t−t₁+p)−θ(t−d′_{b})]−[Θ(t−t₂+p)−Θ(t−d′_{b})]=[Θ(t−t₁+p)−Θ(t−t₂+p)]. For request rᵢ₊₁, the difference of cache occupancy is [θ(t−t₂+p)−Θ(t−dᵢ₊₁)]−[Θ(t−t₁+p)−Θ(t−dᵢ₊₁)]=[Θ(t−t₂+p)−Σ(t−t₁+p)]. Therefore the G_{S′}(t)=G_{S}(t)≦C/p.

The cache increase for s_{b} is cancelled by the cache decrease for sᵢ₊₁. Since request r_{b} is scheduled earlier, there will be no tardiness introduced. Because sᵢ₊₁=t₂<s₁≦d₁≦dᵢ₊₁, there will be no tardiness for request rᵢ₊₁ as well. The last schedule is still s₁=tₘ. This proves Sᵢ₊₁′ is as good as Sᵢ₊₁. In the same fashion, we can swap request rᵢ₊₁ with the next scheduled request after request r_{b}, until to swap with the last schedule in Sᵢ₊₁. This proves to schedule request rᵢ₊₁ after the last schedule of the previous i requests is at least as good as to schedule between the previous schedule for i requests.

It was previously shown that if request rᵢ₊₁ is scheduled after the last schedule of previous i requests, ETSO algorithm gives the earliest possible sᵢ₊₁.
We show S₂ is optimal when i=1,2. Assuming Sᵢ is optimal for first i requests, we show Sᵢ₊₁*={Sᵢ, sᵢ₊₁=t′} is an optimal schedule for first (i+1) requests. This proves a schedule based on ETSO algorithm is at least as good as any other schedule, i.e., an optimal schedule.

While the invention has been described and illustrated in sufficient detail that those skilled in this art can readily make and use it, various alternatives, modifications, and improvements should become readily apparent without departing from the spirit and scope of the invention. Specifically, the present invention is not limited to CDNs using remote site downloading function. The present invention is applicable in all cached network environments.

1. A method of scheduling downloading for a downloading system comprising:
receiving a request for a content file, the request having a service time and a specified cache server;
listing the request in a job list in chronological order according to service time. the job list having a scheduling pointer initialized to a request for a content file at a top of the job list;
determining whether the content file required for the request at the scheduling pointer is stored on the specified cache server and whether free space exists on the specified cache server to store the content file required for the request; and
upon determining that the content file required for the request at the scheduling pointer is not stored on the specified cache server and that the free space exists on the specified cache server to store the content file required for the request, downloading the content file required for the request at the scheduling pointer to the specified cache server.

2. The method of claim 1 further comprising upon the downloading being completed, forwarding the scheduling pointer to a next request on the job list.

3. The method of claim 1 further comprising upon determining that the content file required for the request at the scheduling pointer is stored in the specified cache server, linking the request at the scheduling pointer to the stored content file and forwarding the scheduling pointer to the next request on the job list.

4. The method of claim 1 wherein the content file is downloaded to the specified cache server from a content server.

5. The method of claim 1 wherein the job list is stored on and executed by the specified cache server.

6. The method of claim 1 wherein the job list is dynamically updated upon receipt of new requests.

7. The method of claim 1 further comprising:
upon receiving a new request having an earlier service time than all other requests on the job list, inserting the new request in the job list before the request at the scheduling pointer; and
moving the scheduling pointer backward to the new request.

8. The method of claim 1 wherein the specified cache server is a hotspot cache server.

9. The method of claim 1 wherein the request is generated by a user device.

10. The method of claim 1 wherein the request is received by a content server and passed on to the specified cache server.

11. A system comprising:
a cache server having a job list;
means to process a user request that a content file be available on the cache server at a service time;
means to add the request to the job list and arrange the job list in chronological order according to service time. the job list having a scheduling pointer initialized at a request for a content file at a top of the job list;
means to determine whether the content file required by the request at the scheduling pointer is stored on the cache server and whether free space exists on the specified cache server to store the content file required for the request;
means to send a request to a content source to download the content file required by the request at the scheduling pointer to the cache server when it is determined that the content file required for the request at scheduling pointer is not stored on the cache server and that the free space exists on the specified cache server to store the content file required for the request; and
means to grant a downloading request from the cache server.

12. The system of claim 11 further comprising means to move the scheduling pointer forward on the job list when the content file required by the request at the scheduling pointer is downloaded.

13. The system of claim 12 further comprising means to move the scheduling pointer forward on the job list when the content file required for the request at the scheduling pointer is determined to be stored on the cache server.

14. The system of claim 11 further comprising means to link the content file required by the request at the scheduling pointer to the request at the scheduling pointer upon the content file required by the request at the scheduling pointer being determined to be stored in the cache server.

15. The system of claim 11 further comprising a content source from which content files are downloaded to the cache server.

16. The system of claim 11 further comprising means to dynamically update the job list upon receipt of new requests, wherein when a new request is received that has an earlier service time than all other requests on the job list, the new request is inserted before the request at the scheduling pointer and the scheduling pointer is moved backward to the new request.

17. The system of claim 11 wherein the cache server is a hotspot cache server.

18. The system of claim 11 wherein the content source is a content server or another cache server on which the content file is stored.
